(19) United States
(12) Patent Application Publication
(10) Pub. No.: US 2026/0126399 A1
(43) Pub. Date: May 7, 2026

(54) SHAPE EVALUATION METHOD OF THERMALLY CONDUCTIVE ADHESIVE AND METHOD FOR MANUFACTURING BATTERY MODULES USING THE SAME

(71) Applicant: SK ON CO., LTD., Seoul (KR)

(72) Inventors: Hyeon Su KIM, Daejeon (KR); Su Min KWON, Daejeon (KR); Jeong Been KIM, Daejeon (KR)

(21) Appl. No.: 19/379,762

(22) Filed: Nov. 5, 2025

(30) Foreign Application Priority Data
Nov. 6, 2024 (KR) 10-2024-0155971

(51) Int. Cl. G01N 21/95; C09J 5/00; C09J 9/00; G01B 11/06; H01M 10/613; H01M 10/653

(52) U.S. Cl. CPC G01N 21/95; C09J 5/00; C09J 9/00; G01B 11/0616; H01M 10/613; H01M 10/653; C09J 2203/33

(57) ABSTRACT

The present disclosure provides a shape evaluation method of a thermally conductive adhesive, including collecting two-dimensional shape information of a measurement site of the thermally conductive adhesive distributed on a substrate, dividing the measurement site into two or more units, measuring heights of each unit to evaluate a thickness of the measurement site, and measuring shading of each unit to evaluate a discontinuity of the measurement site.

### CROSS-REFERENCE TO RELATED APPLICATIONS

This application claims priority under 35 U.S. C. § 119 to Korean Patent Application No. 10-2024-0155971, filed on Nov. 6, 2024, in the Korean Intellectual Property Office, the disclosure of which is incorporated herein by reference in its entirety.

### TECHNICAL FIELD

The following disclosure relates to a shape evaluation method of a thermally conductive adhesive and a method for manufacturing a battery module using the same.

### BACKGROUND

Secondary batteries may be charged and discharged, and thus, may be applied to various fields such as digital cameras, mobile phones, laptop computers, hybrid vehicles, and electric vehicles. Among these secondary batteries, many studies are being conducted on lithium secondary batteries having high energy density and discharge voltage. The lithium secondary battery is manufactured as a pouched type battery cell having flexibility or a prismatic battery cell or a cylindrical can type battery cell having rigidity.

A plurality of battery cells are mounted on a module case in units of cell stacks in which the battery cells are stacked and electrically connected to each other, thereby constituting a battery system such as a battery module or a battery pack. The battery systems are installed and used in electric vehicles, etc. It is very important to secure the safety of such battery systems. In particular, when a flame is generated from a battery cell due to an abnormal phenomenon and spreads to other nearby battery cells, thermal runaway may occur, which may lead to additional fires or explosions. Therefore, a structure capable of preventing the spread of a flame generated inside a battery cell is required.

In this case, when the thermally conductive adhesive is not applied uniformly, poor contact between the battery cell and the case may reduce the mechanical strength of the coupling, which may in turn reduce the durability of the battery module. In addition, when voids or delamination occur in the thermally conductive adhesive, heat is not adequately transferred to increase the temperature of the battery cell, thereby posing a risk of shortened battery cell lifespan. Therefore, there is a need to develop a method for evaluating whether a thermally conductive adhesive is properly applied to optimize the thermal performance of a battery module.

### SUMMARY

An embodiment of the present disclosure is directed to providing a shape evaluation method of a thermally conductive adhesive capable of determining whether the thermally conductive adhesive is poorly distributed by inspecting whether the thermally conductive adhesive is normally distributed.

Another embodiment of the present disclosure is directed to providing a shape evaluation method of a thermally conductive adhesive that is stable and effective in consideration of surface noise of the thermally conductive adhesive.

According to one aspect of the present disclosure, the shape evaluation method of a thermally conductive adhesive having the above-described advantages may provide optimal process conditions in a battery module process, and furthermore, may be widely applied in green technology fields such as electric vehicles, battery charging stations, and solar and wind power generation using batteries.

In one general aspect, a shape evaluation method of a thermally conductive adhesive includes: collecting two-dimensional shape information of a measurement site of the thermally conductive adhesive distributed on a substrate; dividing the measurement site into two or more units; measuring heights of each unit to evaluate a thickness of the measurement site; and measuring shading of each unit to evaluate a discontinuity of the measurement site.

The measurement site may be equally divided into two or more units.

In the collecting of the two-dimensional shape information, length and height information of the measurement site may be collected using a direction in which the adhesive is distributed and a direction perpendicular to the distribution direction as an x-axis and a y-axis, respectively.

The height information of the measurement site may be calculated by correcting a height of a lowermost end portion of the measurement site as a reference value.

The two-dimensional shape information may be measured using a phase measurement method or a laser scanning technique.

The evaluating of the thickness of the measurement site may include: calculating maximum values of the heights of each unit at 10th to 40th percentiles of a volume-weighted distribution of the measurement site; and calculating an average value of the maximum values of the heights of each unit.

In the evaluating of the thickness of the measurement site, when the average value differs from a predetermined height threshold value, the adhesive distribution may be determined to be defective.

The evaluating of the discontinuity of the measurement site may include: measuring a continuous length from one end of the measurement site to the other end based on a change in shading of each unit; and determining the adhesive distribution as a defect when the measured length differs from the predetermined length threshold value.

The continuous length of the measurement site may be a length from one end of the measurement site to a portion where the change in the shading differs from the predetermined threshold value for a total area of each unit.

In another general aspect, a method for manufacturing a battery module includes: distributing a thermally conductive adhesive on a battery module case; evaluating a shape of the thermally conductive adhesive that includes collecting two-dimensional shape information of a measurement site of the thermally conductive adhesive, dividing the measurement site into two or more units, measuring heights of each unit to evaluate a thickness of the measurement site, and measuring shading of each unit to evaluate a discontinuity of the measurement site; and assembling the battery module by coupling the battery module case and a battery cell stack that pass through the evaluation.

The measurement site may be equally divided into two or more units.

In the distributing of the thermally conductive adhesive, the thermally conductive adhesive may be distributed at one or more positions selected from among between the battery module accommodated in the battery module case and the cell stack, between the battery cells, and one side of the battery cell stack.

In the collecting of the two-dimensional shape information, length and height information of the measurement site may be collected using a direction in which the adhesive is distributed and a direction perpendicular to the distribution direction as an x-axis and a y-axis, respectively.

The evaluating of the thickness of the measurement site may include: calculating maximum values of the heights of each unit at 10th to 40th percentiles of a volume-weighted distribution of the measurement site; and calculating an average value of the maximum values of the heights of each unit.

In the evaluating of the thickness of the measurement site, when the average value differs from a predetermined height threshold value, the adhesive distribution may be determined to be defective.

The evaluating of the discontinuity of the measurement site may include: measuring a continuous length from one end of the measurement site to the other end based on a change in shading of each unit; and determining the adhesive distribution as a defect when the measured length differs from the predetermined length threshold value.

The continuous length of the measurement site may be a length from one end of the measurement site to a portion where the change in the shading differs from the predetermined threshold value for a total area of each unit.

### BRIEF DESCRIPTION OF THE DRAWINGS

FIG. 1 is a diagram illustrating a two-dimensional shape image of a measurement site of a distributed thermally conductive adhesive divided into two or more units, according to a shape measurement method for a thermally conductive adhesive of the present disclosure.

FIG. 2 is a diagram illustrating calculating heights of each unit, according to the shape measurement method for a thermally conductive adhesive of the present disclosure.

FIG. 3 is a diagram illustrating a method for evaluating a discontinuity of a measurement site of a distributed thermally conductive adhesive, in a method for measuring a shape of a thermally conductive adhesive of the present disclosure.

### DETAILED DESCRIPTION OF EMBODIMENTS

Hereinafter, the present disclosure will be described in more detail. However, this is merely exemplary, and the present disclosure is not limited to the specific embodiments described by way of example. Unless otherwise defined, the terms used herein shall be construed as having the meanings generally understood by those of ordinary skill in the art.

The singular forms used in the specification are intended to include the plural forms as well, unless the context specifically dictates otherwise.

In addition, numerical ranges as used herein include all possible combinations of lower and upper limits and all values within that range, increments logically derived from the form and width of the defined ranges, all values defined herein, and upper and lower limits of numerical ranges defined in different forms. Unless otherwise defined in the specification of the present disclosure, values out of a numerical range that may occur due to experimental errors or rounding of values are also included in the defined numerical range.

In this specification, the terms “include”, “have”, “comprise”, etc., means that features or components described in the specification are present, and unless specifically limited, it does not preclude in advance the possibility that one or more other features or components may be added.

The term “measurement site” as described herein refers to a portion of the thermally conductive adhesive, which is applied continuously or discontinuously on a substrate, in which a start point and an end point can be specified, but is not limited to a region of interest (ROI) for which the shape of the applied thermally conductive adhesive is to be evaluated.

The term “unit” as used herein refers to each segment in which a measurement site on a substrate, to which a thermally conductive adhesive is applied, is divided (specifically, each segment in which a measurement site on a substrate, to which a thermally conductive adhesive is applied, is equally divided), and may be one divided into equal lengths based on an adhesion direction of the measurement site, but is not limited thereto.

A shape evaluation method of a thermally conductive adhesive of the present disclosure includes: collecting two-dimensional shape information of a measurement site of the thermally conductive adhesive distributed on a substrate; dividing the measurement site into 5 to 30 units; measuring heights of each unit to evaluate a thickness of the measurement site; and measuring shading of each unit to evaluate a discontinuity of the measurement site.

Specifically, the measurement site may be equally divided into 5 to 30 units.

Specifically, the thermally conductive adhesive may be distributed on the substrate by being applied, sprayed, coated, or injected to the substrate. However, the method for applying a thermally conductive adhesive to a substrate is not limited thereto.

The present disclosure relates to a shape evaluation method of a thermally conductive adhesive that evaluates, as a normal distribution, a case where a thickness of the measurement site of the thermally conductive adhesive meets a predetermined threshold value and a length of the measurement site in an adhesion direction is continuously distributed without interruption up to a predetermined threshold value. Accordingly, the present disclosure may provide a stable and highly effective shape evaluation method of a thermally conductive adhesive.

Specifically, the thermally conductive adhesive may be an epoxy resin, but any material with high thermal conductivity is not limited thereto. In addition, the thermally conductive adhesive may be disposed between a battery module case and a cell stack in a liquid or gel form to buffer swelling of cells and transfer heat generated from the cells to the battery module case, thereby enhancing cooling and heat dissipation performance between the battery module case and the cell stack.

Accordingly, the shape evaluation method of a thermally conductive adhesive of the present disclosure may indirectly improve the cooling and heat dissipation performance of the battery module when used in a battery module manufacturing process, thereby achieving superior quality.

Specifically, the measurement site of the applied adhesive may be divided into 2 to 100 units, and more specifically, may be divided into 2 to 50, 5 to 40, 10 to 30, or 10 to 20 units.

More specifically, the measurement site of the applied adhesive may be equally divided into 2 to 100 units, and more specifically, may be equally divided into 2 to 50, 5 to 40, 10 to 30, or 10 to 20 units.

The two-dimensional shape information may be measured using a phase measurement method or a laser scanning technique. For example, an image acquisition device may continuously acquire images while moving along the measurement site in the adhesion direction of the thermally conductive adhesive. In this case, the image acquisition method may apply various image processing techniques, and is not particularly limited.

According to the shape evaluation method of a thermally conductive adhesive of the present disclosure, in the collecting of the two-dimensional shape information, length and height information of the measurement site may be collected using a direction in which the adhesive is applied and a direction perpendicular to the application direction as an x-axis and a y-axis, respectively.

In addition, the thickness information of the measurement site may be calculated by correcting a height of a lowermost end portion of the measurement site as a reference value. For example, the thickness information of the measurement site may be obtained by calculating a relative height of an uppermost portion of the measurement site based on the height of the lowermost end portion of the measurement site. Accordingly, after the two-dimensional shape measurement, the tilt of the substrate on which the adhesive is distributed may be corrected to accurately measure the height information of the thermally conductive adhesive.

In the shape evaluation method of a thermally conductive adhesive of the present disclosure, the evaluating of the thickness of the measurement site may include calculating maximum values of heights of each unit from 10th to 40th percentiles of a volume-weighted distribution of the measurement site; and calculating an average value of the maximum values of the heights of each unit.

In this case, the average value of the maximum values of the heights of each unit, rather than the maximum values of the heights of each unit, is used as an indicator for evaluating the thickness of the measurement site, thereby improving noise issues occurring on an uneven surface.

Specifically, the 10th to 40th percentiles of the volume-weighted distribution of the measurement site refer to calculating the maximum values of the heights of each unit by considering only the volumes of the upper 10th to 40th percentiles of the measurement site in the y-axis direction. The 10th to 40th percentiles may be 10th to 30th percentiles, and more specifically, the 10th to 20th percentiles.

In addition, in the evaluating of the thickness of the measurement site, when the average value of the maximum values of heights of each unit calculated by the above-described method differs from a predetermined height threshold value, the adhesive distribution may be determined to be defective. Accordingly, an effective evaluation method may be provided for noise and irregularly distributed shapes present on an upper surface of the thermally conductive adhesive distribution.

Specifically, the predetermined height threshold value may be a continuous range including a first threshold value and a second threshold value, but is not limited thereto. For example, when the average value of the maximum values of the heights is greater than or equal to the predetermined first threshold value and less than or equal to the predetermined second threshold value, the substrate on which the thermally conductive adhesive is distributed may be determined to be in a good state, and when the average value of the maximum values of the heights is less than the predetermined first threshold value or exceeds the predetermined second threshold value, the substrate on which the thermally conductive adhesive is distributed may be determined to be in a defective state. In this case, the method may further include finally determining whether the substrate determined to be a defective product is in a good or defective state based on a determination of a manager. Specifically, the height threshold value may be 1 mm or greater, but is not limited thereto.

In the shape evaluation method of a thermally conductive adhesive of the present disclosure, the evaluating of the discontinuity of the measurement site may include measuring a continuous length from one end of the measurement site to the other end based on a change in shade of the measurement site; and determining the adhesive distribution as a defect when the measured length differs from the predetermined length threshold value.

In the evaluating of the discontinuity of the measurement site, the continuous length of the measurement site may be a length from one end of the measurement site to a portion where the change in the shading differs from a predetermined threshold value for the total area of each unit.

Specifically, in the collected two-dimensional shape information, the thermally conductive adhesive is represented as white pixels against a black background. When the total area of each unit in the measurement site is assumed to be 100, the length may be measured up to the portion where the area occupied by black pixels relative to the total area is greater than or equal to a predetermined threshold ratio.

Specifically, the predetermined length threshold value may be a continuous range including a third threshold value and a fourth threshold value, but is not limited thereto. For example, when the measured length is greater than or equal to the predetermined third threshold value and less than or equal to the predetermined fourth threshold value, the substrate on which the thermally conductive adhesive is distributed may be determined to be in a good state, and when the measured length is less than the predetermined third threshold value or exceeds the predetermined fourth threshold value, the substrate on which the thermally conductive adhesive is distributed may be determined to be in a defective state. In this case, the shape evaluation method may further include finally determining whether the substrate determined to be a defective product is in a good or defective state based on a determination of a manager.

The shape evaluation method of a thermally conductive adhesive of the present disclosure may perform collecting two-dimensional shape information of a measurement site of the thermally conductive adhesive distributed on a substrate and dividing the measurement site into two or more units, and then measuring heights of each unit to evaluate a thickness of the measurement site and measuring shading of each unit to evaluate a discontinuity of the measurement site, in which the evaluating of the thickness and the evaluating of the discontinuity may be performed without being limited to a particular order.

In addition, in the shape evaluation method of a thermally conductive adhesive, when the distribution of the thermally conductive adhesive passes through both the thickness and discontinuity evaluations, the distribution of the thermally conductive adhesive is determined to be non-defective, and when either or both of the thickness and discontinuity evaluations are not met, the distribution of the thermally conductive adhesive may be determined to be defective.

A method for manufacturing a battery module of the present disclosure may include: distributing a thermally conductive adhesive on a battery module case; evaluating of a shape of the thermally conductive adhesive that includes collecting two-dimensional shape information of a measurement site of the thermally conductive adhesive distributed on a substrate, dividing the measurement site into two or more units, measuring heights of each unit to evaluate a thickness of the measurement site, and measuring shading of each unit to evaluate a discontinuity of the measurement site; and assembling the battery module by coupling the battery module case and a battery cell stack that pass through the evaluation.

According to one implementation example, the measurement site may be equally divided into two or more units.

According to one implementation example, in the distributing of the thermally conductive adhesive of the present disclosure, the thermally conductive adhesive may be distributed at one or more positions selected from among between the battery module accommodated in the battery module case and the cell stack, between the battery cells, and one side of the battery cell stack.

The battery cell is a rechargeable secondary battery, and may include a lithium secondary battery. The lithium secondary battery may be formed as a flexible pouch-type battery cell or a rigid prismatic battery cell.

The battery module case forms an outer appearance of the battery module and protects the components accommodated therein from the external environment. As the battery module case, an exterior material in the form of a film in which a surface of a metal thin film is subjected to insulating treatment may be used. The metal thin film may be formed of aluminum, and the insulation treatment is carried out by applying modified polypropylene, such as casted polypropylene (CPP), which is a polymer resin, to form a heat-sealing layer, and a resin material, such as nylon or polyethylene terephthalate (PET), may be formed on an outer side surface thereof.

The thermally conductive adhesive has high insulation properties. For example, a material having a dielectric strength in the range of 10 to 30 kV/mm may be used.

According to one implementation example, in the collecting of the two-dimensional shape information, the length and height information of the measurement site may be collected using the direction in which the adhesive is distributed and the direction perpendicular to the distribution direction as the x-axis and the y-axis, respectively.

According to one implementation example, the evaluating of the thickness of the measurement site may include: calculating maximum values of the heights of each unit at 10th to 40th percentiles of a volume-weighted distribution of the measurement site; and calculating an average value of the maximum values of the heights of each unit.

According to one implementation example, in the evaluating of the thickness of the measurement site, when the average value differs from a predetermined height threshold value, the adhesive distribution may be determined to be defective.

According to one implementation example, the evaluating of the discontinuity of the measurement site may include: measuring a continuous length from one end of the measurement site to the other end based on a change in shading of each unit; and determining the adhesive distribution as a defect when the measured length differs from the predetermined length threshold value.

According to one implementation example, the continuous length of the measurement site may be a length from one end of the measurement site to a portion where the change in the shading differs from the predetermined threshold value for the total area of each unit.

The method for manufacturing a battery module of the present disclosure may maintain the consistent quality of the applied shape of the thermally conductive adhesive, thereby improving the defect rate of the battery module due to the adhesive application defects. Accordingly, in the manufactured battery module, even if the electrical insulation is partially broken in the battery cell, the electrical insulation between the battery cell and the battery module case may be maintained by the thermally conductive adhesive properly applied to the battery cell.

In addition, according to the above-described method, the thermally conductive adhesive applied with excellent quality is disposed in the form in which the thermally conductive adhesive fills the space between the battery cell and the battery module case, thereby reinforcing the overall rigidity of the battery module.

Hereinafter, embodiments of the present disclosure will be further described with reference to specific experimental examples. Examples and comparative examples included in the experimental examples are merely illustrative of the present disclosure and do not limit the scope of the appended claims. It will be apparent to those skilled in the art that various modifications and variations of the examples are possible within the scope and scope of the present invention, and such modifications and variations are also within the scope of the appended claims.

### EXAMPLE 1

### Shape Evaluation Method of Thermally Conductive Adhesive

### Method for Evaluating Adhesive Thickness

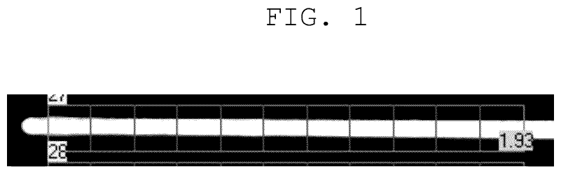

As illustrated in FIG. 1, the two-dimensional shape information of the measurement site was collected for a single line of thermally conductive adhesive beads (thermal adhesive) applied to a substrate. In this case, based on the two-dimensional shape information, the measurement site was equally divided into 11 units.

Thereafter, the slope of the lowermost end portion (base) of each unit was calculated. Setting the slope of the lowermost end portion to 0, the heights of each unit in the y-axis was corrected and calculated.

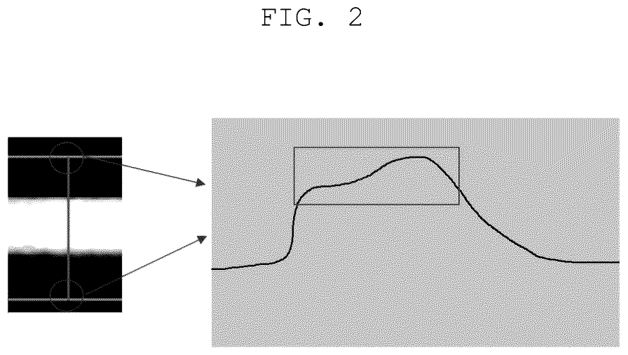

As illustrated in FIG. 2, the maximum values Max₁, Max₂, Max₃, . . . , Max₁₁ of the heights of in each unit in the y-axis direction were calculated in consideration of only 15% of the upper volume of the measurement site in the y-axis direction, and the average value of the calculated maximum values was calculated and was defined as Max_{avg}.

The Max_{avg} value was compared with a predetermined height threshold value, and when the Max_{avg} fell outside the threshold value range, it was determined to be defective. Specifically, the predetermined height threshold value may be 1 mm or greater.

### Method for Evaluating Discontinuity of Adhesive

To evaluate the discontinuity of the adhesive, the continuous length L from one end of the measurement site was measured and compared with the predetermined length threshold value. When L fell outside the threshold value range, it was determined to be defective.

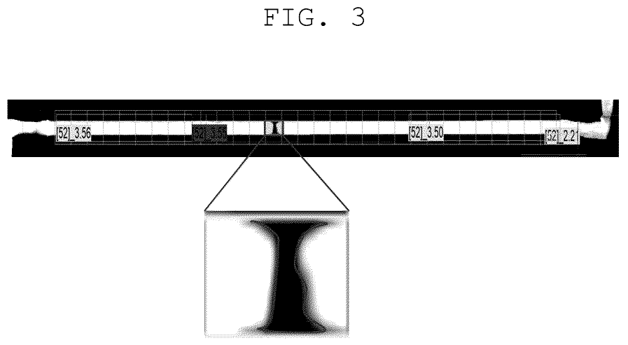

Specifically, as illustrated in FIG. 3, when the total area occupied by each unit is 100, if the black pixels exceed a certain percentage that can be arbitrarily designated, it was determined to be discontinuous.

Based on the evaluation of the thickness and discontinuity of the adhesive, if either of the two requirements is not met, the adhesive application is determined to be defective.

### COMPARATIVE EXAMPLE 1

The method for evaluating a thickness of an adhesive of Example 1 was performed in the same manner as Example 1, except that the largest value, Maxₘₐₓ, among the calculated maximum values Max₁, Max₂, Max₃, . . . , Max₁₁ of the heights of each unit, was calculated and compared with the predetermined height threshold value.

According to the shape evaluation method of a thermally conductive adhesive according to an embodiment of the present disclosure, it is possible to improve the yield and quality problems in the process by solving the over-inspection problem during the inspection process of the product production process.

According to the method for manufacturing a battery module of an embodiment of the present disclosure, by maintaining a consistent distribution pattern of thermally conductive adhesive with uniform quality, it is possible to improve the defect rate of the battery module caused by poor adhesive distribution and to ensure the consistent module performance.

According to the method for manufacturing a battery module of an embodiment of the present disclosure, by improving the cooling and heat dissipation performance of the battery module and enhancing its overall rigidity, it is possible to effectively apply the battery module to various green technology fields that utilize the battery.

Contents described above are merely an example of applying the principles of the present disclosure, and other components may be included without departing from the scope of the present disclosure.

What is claimed is:

1. A shape evaluation method of a thermally conductive adhesive, comprising:
collecting two-dimensional shape information of a measurement site of the thermally conductive adhesive distributed on a substrate;
dividing the measurement site into two or more units;
measuring heights of each unit to evaluate a thickness of the measurement site; and
measuring shading of each unit to evaluate a discontinuity of the measurement site.

2. The shape evaluation method of claim 1, wherein the measurement site is equally divided into two or more units.

3. The shape evaluation method of claim 1, wherein, in the collecting of the two-dimensional shape information, length and height information of the measurement site is collected using a direction in which the adhesive is distributed and a direction perpendicular to the distribution direction as an x-axis and a y-axis, respectively.

4. The shape evaluation method of claim 3, wherein the height information of the measurement site is calculated by correcting a height of a lowermost end portion of the measurement site as a reference value.

5. The shape evaluation method of claim 1, wherein the two-dimensional shape information is measured using a phase measurement method or a laser scanning technique.

6. The shape evaluation method of claim 1, wherein the evaluating of the thickness of the measurement site includes:
calculating maximum values of the heights of each unit at 10th to 40th percentiles of a volume-weighted distribution of the measurement site; and
calculating an average value of the maximum values of the heights of each unit.

7. The shape evaluation method of claim 6, wherein, in the evaluating of the thickness of the measurement site, when the average value differs from a predetermined height threshold value, the adhesive distribution is determined to be defective.

8. The shape evaluation method of claim 1, wherein the evaluating of the discontinuity of the measurement site includes:
measuring a continuous length from one end of the measurement site to the other end based on a change in shading of each unit; and
determining the adhesive distribution as a defect when the measured length differs from the predetermined length threshold value.

9. The shape evaluation method of claim 8, wherein the continuous length of the measurement site is a length from one end of the measurement site to a portion where the change in the shading differs from the predetermined threshold value for a total area of each unit.

10. A method for manufacturing a battery module, comprising:
distributing a thermally conductive adhesive on a battery module case;
evaluating a shape of the thermally conductive adhesive that includes collecting two-dimensional shape information of a measurement site of the thermally conductive adhesive, dividing the measurement site into two or more units, measuring heights of each unit to evaluate a thickness of the measurement site, and measuring shading of each unit to evaluate a discontinuity of the measurement site; and
assembling the battery module by coupling the battery module case and a battery cell stack that pass through the evaluation.

11. The method of claim 10, wherein the measurement site is equally divided into two or more units.

12. The method of claim 10, wherein, in the distributing of the thermally conductive adhesive, the thermally conductive adhesive is distributed at one or more positions selected from among between the battery module accommodated in the battery module case and the cell stack, between the battery cells, and one side of the battery cell stack.

13. The method of claim 10, wherein, in the collecting of the two-dimensional shape information, length and height information of the measurement site is collected using a direction in which the adhesive is distributed and a direction perpendicular to the distribution direction as an x-axis and a y-axis, respectively.

14. The method of claim 10, wherein the evaluating of the thickness of the measurement site includes:
calculating maximum values of the heights of each unit at 10th to 40th percentiles of a volume-weighted distribution of the measurement site; and
calculating an average value of the maximum values of the heights of each unit.

15. The method of claim 14, wherein, in the evaluating of the thickness of the measurement site, when the average value differs from a predetermined height threshold value, the adhesive distribution is determined to be defective.

16. The method of claim 10, wherein the evaluating of the discontinuity of the measurement site includes:
measuring a continuous length from one end of the measurement site to the other end based on a change in shading of each unit; and
determining the adhesive distribution as a defect when the measured length differs from the predetermined length threshold value.

17. The method of claim 16, wherein the continuous length of the measurement site is a length from one end of the measurement site to a portion where the change in the shading differs from the predetermined threshold value for a total area of each unit.
